(19) United States
(12) Patent Application Publication
(10) Pub. No.: US 2024/0254590 A1
(43) Pub. Date: Aug. 1, 2024

(54) METHOD OF METAL RECOVERY WITH COSOLVENT

(71) Applicant: Jetti Resources, LLC, Boulder, CO (US)

(72) Inventors: Zihe Ren, Richmond (CA); Chih Wei Chao, Vancouver (CA); Nelson Mora Huertas, Boulder, CO (US)

(21) Appl. No.: 18/421,625

(22) Filed: Jan. 24, 2024

Related U.S. Application Data
(60) Provisional application No. 63/440,859, filed on Jan. 24, 2023.

(51) Int. Cl. C22B 3/16; C22B 3/04; C22B 3/26

(52) U.S. Cl. CPC C22B 3/1616; C22B 3/045; C22B 3/262

(57) ABSTRACT

The present disclosure relates to the use of a catalyst comprising a thiocarbonyl group and a cosolvent in a method for extracting a base metal from a material comprising the base metal. The method may comprise contacting a material with a catalyst comprising a thiocarbonyl and a cosolvent system, wherein the cosolvent system comprises a solvent and a cosolvent. The method may comprise hydrometallurgical extraction.

### CROSS-REFERENCE TO RELATED APPLICATIONS

This application claims priority to and the benefit of the filing of U.S. Provisional Patent Application No. 63/440,859, entitled “METHOD OF METAL RECOVERY WITH COSOLVENT”, filed on Jan. 24, 2023, and the specification thereof is incorporated herein by reference.

### BACKGROUND OF THE INVENTION

### Field of the Invention (Technical Field)

The present invention relates to the recovery of metal with a catalyst comprising a thiocarbonyl group and a cosolvent.

### DESCRIPTION OF RELATED ART

Note that the following discussion may refer to a number of publications by author(s) and year of publication, and that due to recent publication dates certain publications are not to be considered as prior art vis-a-vis the present invention. Discussion of such publications herein is given for more complete background and is not to be construed as an admission that such publications are prior art for patentability determination purposes.

Chalcopyrite accounts for nearly 70% of known copper reserves. Hydrometallurgical processing accounts for 20% of copper produced worldwide but it is not currently widely used for chalcopyrite ores. Rather, pyrometallurgical methods are used for concentrates of these ores. Aqueous processing of minerals presents several advantages over pyrometallurgical approaches, particularly when dealing with complex and low-grade ores. The main disadvantage of hydrometallurgical processes, when applied to chalcopyrite and some other sulfide ores, is the low extraction rates that are observed due to the formation of a passivation layer that prevents copper from being extracted at reasonable rates. It is desirable to develop processes where passivation is not an issue and high copper extractions can be achieved in timescales that are of industrial interest. Previous methods have been focused on the change of solute composition, particle size as well as external environment such as temperature and pressure to enhance the copper extraction. The default setting is always the use of an aqueous system.

Cosolvent systems have been studied for decades for different purposes. The main objective of using a cosolvent has been for soil remediation where organic contaminants and non-aqueous phase liquid (NAPLs) can be flushed out. For cosolvent flushing, a mixture of water and water-miscible alcohols were the primary composition of the solvent system.

In the field of hydrometallurgy, the use of cosolvent in leaching has been investigated. Solvometallurgy is an emerging technology for metal processing where little or no water is involved. The addition of polar organic solvents such as alcohols to the aqueous acidic solutions can increase the copper extractions. The following table (Table 1) summarizes the experimental conditions and results of previous work:

| Mineral | Co-Solvent | Oxidant | Temperature |
|---|---|---|---|
| Chalcopyrite | Acetone | H₂O₂ | 50° C. |
| Chalcopyrite | Ethylene glycol | H₂O₂ | 50° C. |
| Chalcopyrite | 2-propanol | H₂O₂ | 50° C. |
| Chalcopyrite | [bmim]HSO₄ | O₂ | 40-90° C. |
| Chalcopyrite | Methanol | CuSO₄ and O₃ | 40° C. |
| Chalcopyrite | Ethanol | CuSO₄ and O₃ | 40° C. |
| Chalcopyrite | Ethylene glycol | FeCl₃ | 60° C. |
| Chalcopyrite | Chlorine-chloride- | None | 90° C. |
| | Ethylene glycol | | |

It can be seen from Table 1 that all previous work that involves co-solvent system relies on the use of elevated temperature or aggressive oxidants (such as H₂O₂ and ozone) or strongly toxic solvent (such as chlorine-chloride ethylene glycol) to have beneficial effect on copper extraction. No beneficial effect of using cosolvent systems has been demonstrated in the prior art under ambient environment or with the use of only conventional oxidants such as ferric or cupric ions. Other prior art shows that the solvent used in the leaching process (such as ethylene glycol) does not directly have a beneficial effect in catalyzing the oxidation of chalcopyrite and does not change the reaction mechanism. The cosolvent matrix proposed by all previous literature is hostile to bacteria, making it impractical for operations such as heap/dump leaching that utilizes iron/sulfur oxidizing bacteria. This invention provides a new platform for the adaptation of cosolvent systems with multiple beneficial effects.

### BRIEF SUMMARY OF THE INVENTION

Embodiments of the present invention relate to a method for extracting a base metal from a material, the method comprising: contacting the material under acidic conditions with a cosolvent system and a catalyst comprising a thiocarbonyl. In another embodiment, contacting the material under acidic conditions comprises: contacting the material with an acidic mixture comprising the catalyst comprising a thiocarbonyl.

In another embodiment, the material is agglomerated prior to contact. In another embodiment, the acidic mixture comprises an oxidizing agent. In another embodiment, the oxidizing agent comprises ferric sulfate. In another embodiment, the material comprises an iron-oxidizing bacteria. In another embodiment, the acidic mixture comprises an iron-oxidizing bacteria. In another embodiment, the material comprises a base metal sulfide. In another embodiment, the material comprises an ore. In another embodiment, the base metal comprises copper. In another embodiment, the material comprises a copper sulfide ore. In another embodiment, the copper sulfide ore comprises chalcopyrite.

In another embodiment, the method further comprises adding sulfuric acid to obtain the acidic conditions. In another embodiment, the pH of the acidic mixture is in a range of about 1.5 to about 2.5. In another embodiment, the catalyst comprising a thiocarbonyl is added to the method in monomeric form. In another embodiment, the catalyst comprising a thiocarbonyl is added to the method in the form of the corresponding dimer. In another embodiment, the catalyst comprising a thiocarbonyl comprises thiourea.

In another embodiment, the cosolvent system comprises an acid. In another embodiment, the acid comprises carboxylic acid. In another embodiment, the cosolvent system comprises a cosolvent. In another embodiment, the cosolvent comprises an alcohol. In another embodiment, the alcohol comprises a monohydric alcohol. In another embodiment, the monohydric alcohol comprises propanol. In another embodiment, the alcohol comprises a polyhydric alcohol. In another embodiment, the polyhydric alcohol comprises ethylene glycol. In another embodiment, the cosolvent comprises a solubility in water of about 0.2 g/L to about 10 g/L. In another embodiment, the alcohol is at a concentration in the range of about 0.5% to about 10%.

In another embodiment, the catalyst comprising a thiocarbonyl is at a concentration in the range of about 0.002 mM to about 100 mM. In another embodiment, the acidic mixture comprises ferric chloride. In another embodiment, the material is contacted with the cosolvent system and the catalyst comprising a thiocarbonyl in a method comprising a percolation leach. In another embodiment, the material is contacted with the cosolvent system and the catalyst comprising a thiocarbonyl in a method comprising a heap leach. In another embodiment, the material is contacted with the cosolvent system and the catalyst comprising a thiocarbonyl in a method comprising a percolation leach. In another embodiment, the method further comprises recovering the base metal.

In another embodiment, the contacting of the material with the cosolvent system and the catalyst comprising a thiocarbonyl produces a pregnant leach solution comprising the base metal and the method further comprises recovering the base metal from the pregnant leach solution. In another embodiment, the recovering comprises solvent extraction. In another embodiment, the recovering comprises electrowinning. In another embodiment, the method further comprises a solid-liquid separation. In another embodiment, the method further comprises recovering the catalyst comprising a thiocarbonyl. In another embodiment, the method further comprises recycling the recovered the catalyst comprising a thiocarbonyl for use in the contacting of a further portion of the material. In another embodiment, the material is contacted with the cosolvent system and the catalyst comprising a thiocarbonyl at ambient temperature and pressure. In another embodiment, the method is a batch method. In another embodiment, the method is a continuous method.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a graph showing the surface tension for different solvents, according to an embodiment of the invention;

FIG. 2 is a graph showing copper recovery over time for a control and a solvent comprising 10% ethylene glycol (“EG”), according to an embodiment of the invention;

FIG. 3 is a graph showing copper recovery over time for a control, control with added catalyst, and control added catalyst and EG, according to an embodiment of the invention;

FIG. 4 is a graph showing the percentage of remaining catalyst during metal recovery with catalyst and different cosolvents, according to an embodiment of the invention;

FIG. 5 is a graph showing the percentage of remaining formamidine disulfide (“FDS”) during metal recovery with FDS and different cosolvents, according to an embodiment of the invention;

FIG. 6 is a graph showing copper recovery in a chloride media with and without the addition of EG and 1-propanol (“1-P”), according to an embodiment of the invention;

FIG. 7 is a graph showing copper recovery in a modified chloride media with and without the addition of EG and 1-P, according to an embodiment of the invention;

FIG. 8 is a graph showing copper recovery over time for a control and a solvent comprising tris(hydroxymethyl)propane and/or pentaerythritol, according to an embodiment of the invention;

FIG. 9 is a graph showing remaining thiourea after ten days with and without the presence of ethanol or gluconic acid, according to an embodiment of the invention; and

FIG. 10 is a graph showing copper recovery from a chalcopyrite concentrate with a control, with the addition of thiourea, with the addition of thiourea and oxalic acid, according to an embodiment of the invention.

### DETAILED DESCRIPTION OF THE INVENTION

This invention relates to a method for the recovery of a base metal from a material comprising: contacting a material with a catalyst comprising a thiocarbonyl and a cosolvent system, wherein the cosolvent system comprises a solvent and a cosolvent; extracting the metal from the material into a solution; and recovering the base metal from the solution. The method may comprise hydrometallurgical extraction. The base metal may comprise copper or other base metals. The cosolvent may comprise an hydroxyl group and the solvent may comprise water and/or an aqueous solution. The material may comprise a metal sulfide. The metal sulfide may be a copper sulfide or other metal sulfides.

The term “base metal” as used herein refers to any suitable metal or combination thereof that does not comprise a precious metal (e.g., gold or platinum). Suitable base metals may include, but are not limited to, copper, nickel, iron, aluminum, lead, zinc, tin, tungsten (also sometimes referred to as wolfram), molybdenum, tantalum, magnesium, cobalt, bismuth, cadmium, titanium, zirconium, antimony, manganese, beryllium, chromium, germanium, vanadium, gallium, hafnium, indium, niobium (also sometimes referred to as columbium), rhenium, thallium, and a combination thereof. The material may comprise a sulfide ore, a copper sulfide, a nickel sulfide, a cadmium sulfide, or a combination thereof. The copper sulfide may be a primary copper sulfide (e.g., chalcopyrite, bornite, enargite or a combination thereof), a secondary copper sulfide (e.g., covellite, chalcocite or a combination thereof), or a combination thereof. The copper sulfide may comprise a primary copper sulfide, a secondary copper sulfide, or a combination thereof. The copper sulfide may comprise chalcopyrite, bornite, enargite, covellite, chalcocite, a copper sulfide of the formula CuxSy wherein the x:y ratio is between 1 and 2, or a combination thereof. The copper sulfide of the formula CuxSy wherein the x:y ratio is between 1 and 2 may comprise chalcocite, djurleite, digenite, or a combination thereof. The nickel sulfide may comprise pentlandite, violarite or a combination thereof. The cadmium sulfide may comprise greenockite. Base metal sulfides other than copper sulfide, nickel sulfide, and/or cadmium sulfide are well known to the person skilled in the art.

The term “recovery” is defined in the specification and drawings as a process used to liberate, extract, free, or remove metal or metals from a material.

The terms “catalyst” and “catalyst comprising a thiocarbonyl” are used interchangeably throughout the specification and drawings.

The present invention relates to a hydrometallurgical process for the recovery of metal from a material using a water and alcohol cosolvent system. Compared with an entirely aqueous solvent, the use of a cosolvent has several advantages including: enhancing the wettability of the cosolvent system by lowering its surface tension; providing a chemical catalytic effect through certain functional groups; and stabilizing catalysts. The use of a cosolvent system may also be compatible with both bioleaching processes (e.g., using iron/sulfur oxidizing bacteria) and chloride leaching processes.

The method does not rely on the use of aggressive oxidizing reagents (e.g., ozone and H₂O₂), elevated temperature, or an ionic liquid. This method allows base metal recovery to be enhanced without compromising other operating parameters and under ambient temperature and/or pressure.

The beneficial effects from the cosolvents include, but are not limited to, assisting the delivery of oxidants and catalyst to a material's surface by lowering the material's surface tension; stabilizing the catalyst comprising the thiocarbonyl and its derivatives in an acidic mixture; providing a synergistic effect between cosolvent and catalyst comprising a thiocarbonyl; and/or enhancing base metal recovery by using an alcohol as cosolvent in an acidic ferric chloride and/or cupric chloride solution.

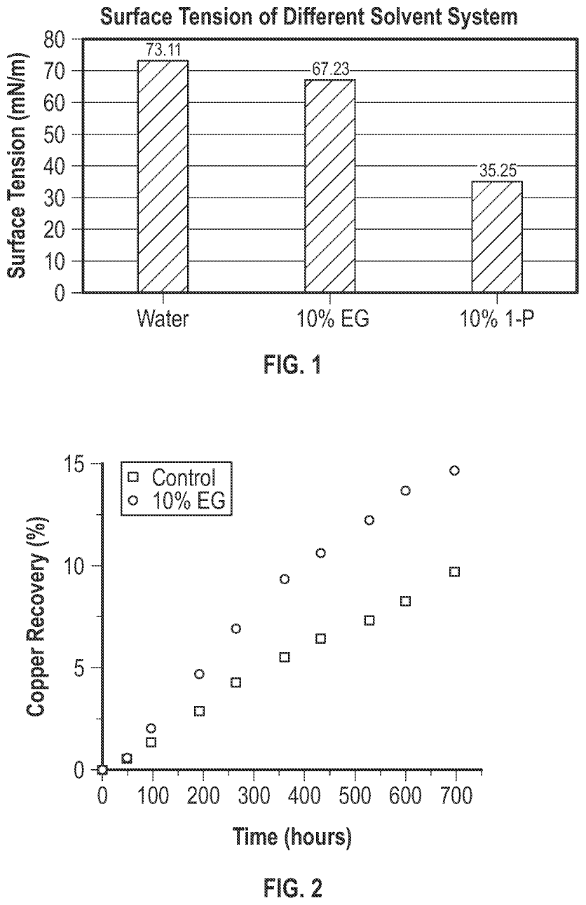

Turning now to the figures, FIG. 1 shows the surface tension of different cosolvent systems. Surface tension is greatest for water and least for 10% 1-P.

FIG. 2 shows the recovery of copper from chalcopyrite with and without the addition of 10% ethylene glycol as a co-solvent in a chemical leaching system. Copper recovery is increased with the addition of 10% EG compared to control.

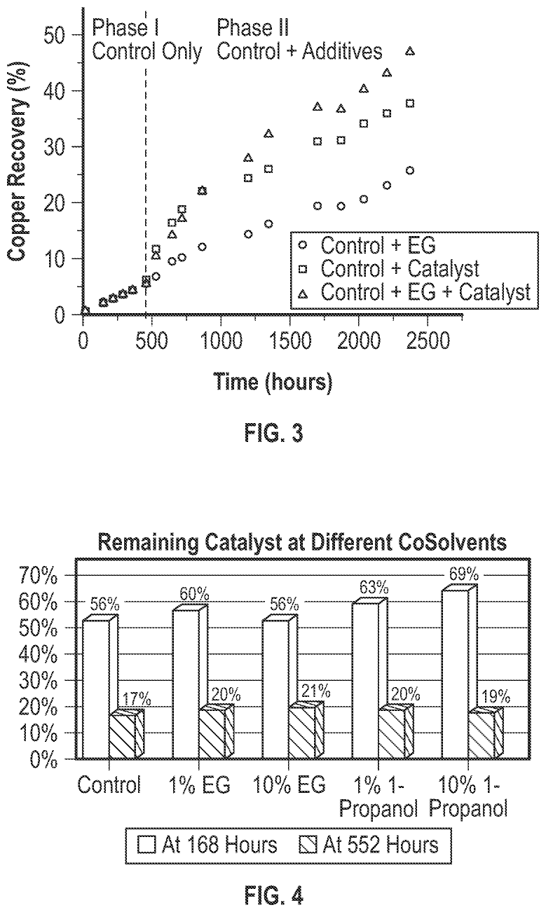

FIG. 3 shows the recovery of copper from chalcopyrite under control condition (phase 1), followed with the addition of 0.5 mM of catalyst and 0.5 mM of catalyst with 1% ethylene glycol as co-solvent in phase 2. The addition of 0.5 mM of catalyst increases copper recovery relative to control. The addition of 0.5 mM of catalyst and 1% ethylene glycol increases copper recovery relative to both control and control with of 0.5 mM of catalyst.

FIG. 4 shows the effect of ethylene glycol and 1-propanol in stabilizing catalyst in acidic ferric sulfate media. The catalyst is stable after 168 hours and 552 hours in all cosolvents relative to the control.

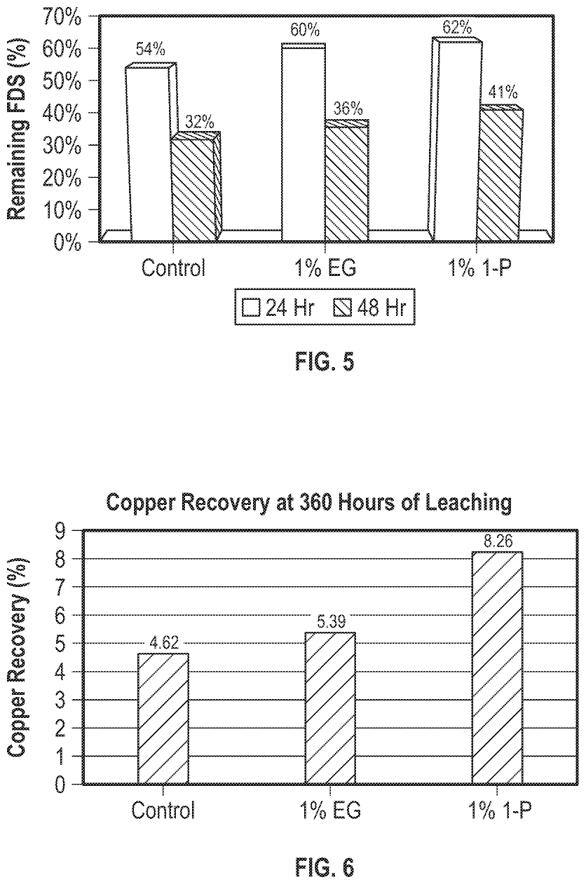

FIG. 5 shows the effect of ethylene glycol and 1-propanol in stabilizing formamidine disulfide (FDS) in acidic sulfate media. The FDS is stable after 24 hours and 48 hours in both cosolvents relative to the control.

FIG. 6 shows the recovery of copper from a chalcopyrite sample with chloride media with and without the addition of 1% ethylene glycol or 1% 1-propanol. Recovery of copper is improved at 360 hours with the addition of 1% ethylene glycol or 1% 1-propanol.

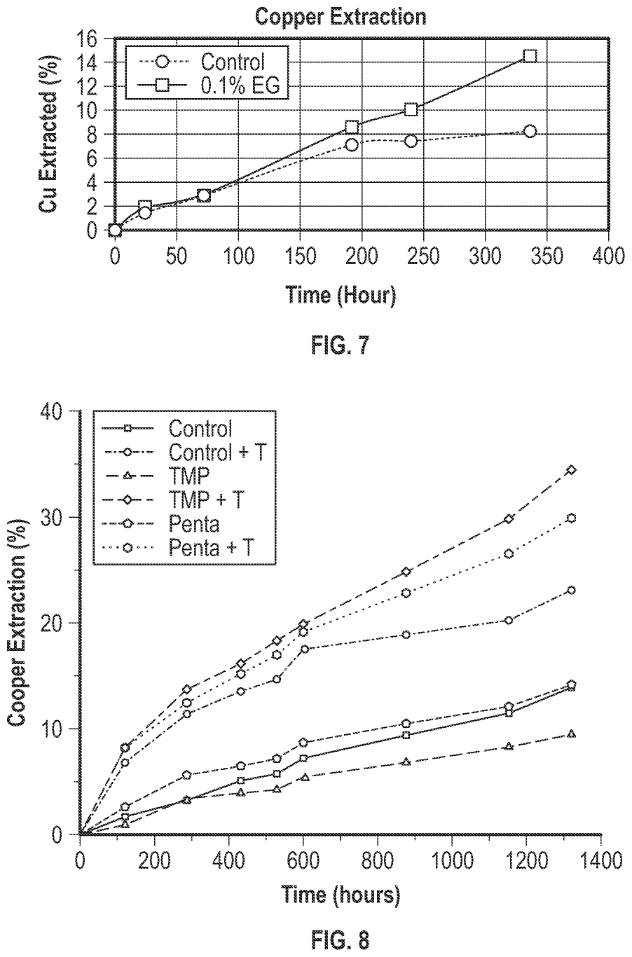

FIG. 7 shows the recovery of copper from a chalcopyrite sample with Fe³⁺-modified chloride media with and without the addition of 1% ethylene glycol and 1% of 1-propanol respectively. Recovery of copper is improved over time with the addition of 0.1% 1-propanol.

FIG. 8 shows the recovery of copper from a chalcopyrite sample with an acidic ferric sulfate leach with and without the addition of thiourea (T), tris(hydroxymethyl)propane (TMP), and/or pentaerythritol (Penta). Recovery of copper is improved over time with the addition thiourea and is improved further with the addition of thiourea and either TMP or Penta.

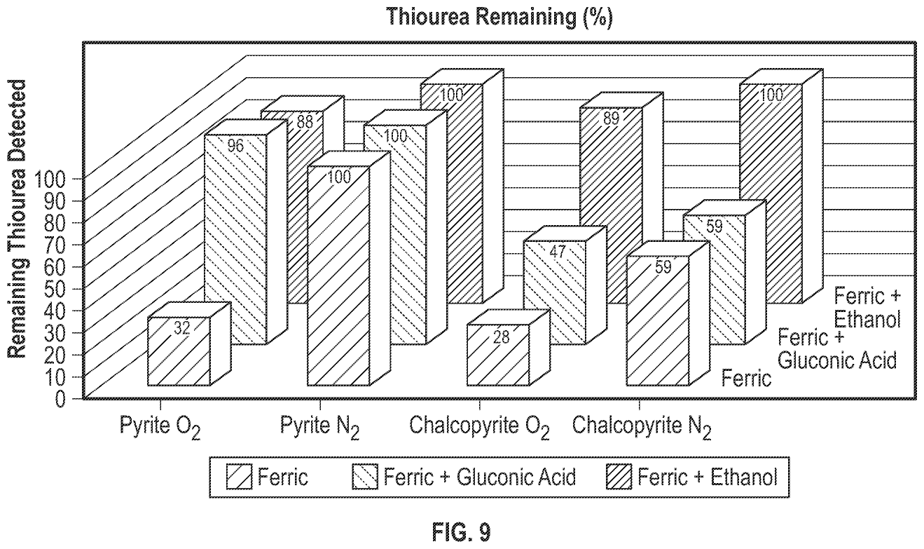

FIG. 9 shows remaining thiourea after ten days with and without the presence of ethanol or gluconic acid. Pyrite and chalcopyrite are subjected to a ferric extraction in the presence of thiourea alone or in combination ethanol or gluconic acid. Oxygen and nitrogen gas are shown as purging gases. Both gluconic acid and ethanol reduce the degradation of thiourea with both oxygen and nitrogen purging gases.

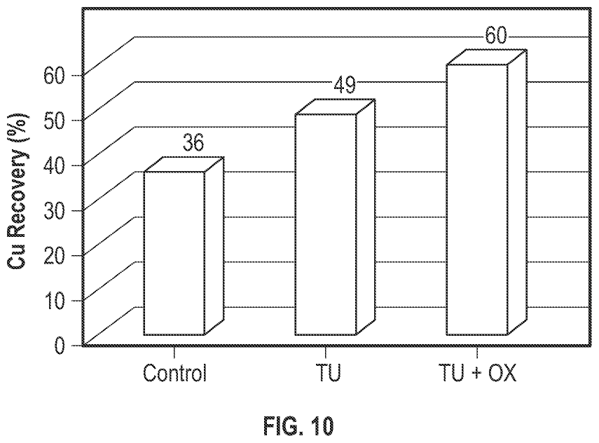

FIG. 10 is a graph showing copper recovery from a chalcopyrite concentrate with a control, with the addition of thiourea, with the addition of thiourea and oxalic acid. Copper recovery is increased with thiourea and further increases with a combination of thiourea and oxalic acid.

The alcohol may comprise a monohydric alcohol including, but not limited to, methanol, ethanol, 1-propanol, isopropanol, 1-butanol, 2-butanol, iso-butanol, sec-butanol, tert-butanol, 1-pentanol, 2-methyl-1-butanol, 3-methyl-1-butanol, 2,2-dimethyl-1-propanol, 2-pentanol, 3-methyl-2-butanol, 3-pentanol, 2-methyl-2-butanol, hexanol, heptanol, or a combination thereof; The alcohol may also comprise a polyhydric alcohol including, but not limited to, ethylene glycol, propylene glycol, 1,2-propanediol, 1,3-propanediol, 1,2-butanediol, 1,3-butanediol, 1,4-butanediol, 2,3-butanediol, glycerol, trimethylolpropane, xylitol, 1,1,1-tris(hydroxymethyl)propane, pentaerythritol, or a combination thereof. The alcohol may comprise a solubility in water of at least about 0.2 g/L, about 0.2 g/L to about 300.0 g/L, about 0.5 g/L to about 275 g/L, about 1.0 g/L to about 250 g/L, about 5 g/L to about 225 g/L, about 10 g/L to about 200 g/L, about 20 g/L to about 175 g/L, about 50 g/L to about 150 g/L, about 75 g/L to about 125 g/L, or about 300.0 g/L.

The monohydric alcohol and/or polyhydric alcohol may be at a concentration of at least about 2%, about 2% to about 25%, about 4% to about 22%, 6% to about 20%, about 8% to about 18%, about 10% to about 16%, about 12% to about 14%, or about 25%. The alcohol may be derived from a methyl ester, ethyl ester, cellulosic material, propyl ester, isopropyl ester, butyl ester, or a combination thereof. The derivation may be achieved by hydrolysis and/or fermentation.

The cosolvent may comprise polyethylene glycol. The polyethylene glycol may be at a concentration of at least about 2%, about 2% to about 50%, about 5% to about 45%, 10% to about 40%, about 15% to about 35%, about 20% to about 30%, or about 50%. The polyethylene glycol may comprise a molecular weight of at least about 500 g/mol, about 500 g/mol to about 4500 g/mol, about 750 g/mol to about 4250 g/mol, about 1000 g/mol to about 4000 g/mol, about 1250 g/mol to about 3750 g/mol, about 1500 g/mol to about 3500, g/mol, about 1750 g/mol to about 3250 g/mol, about 2000 g/mol to about 3000 g/mol, about 2250 g/mol to about 2750 g/mol, or about 4500 g/mol.

The cosolvent system may comprise an acid. The acid may comprise a carboxylic acid with or without a hydroxyl substitution. The carboxylic acid may comprise a polyprotic carboxylic acid. The acid may comprise an alcohol feature. The acid may include, but is not limited to, oxalic acid, malonic acid, succinic acid lactic acid, phthalic acdic, citric acid, tartaric acid, glycolic acid, malic acid, ascorbic acid, gluconic acid, mandelic acid, hydroxycitric acid, kojic acid, or a combination thereof. The acid may be at a concentration of at least about 2 mM, about 2 mM to about 25 mM, about 4 mM to about 22 mM, 6 mM to about 20 mM, about 8 mM to about 18 mM, about 10 mM to about 16 mM, about 12 mM to about 14 mM, or about 25 mM.

The method may comprise recovering a base metal from a material by dissolving an alcohol in an acidic solution (e.g., ferric sulfate solution, a ferric chloride solution, and/or a cupric chloride solution). The alcohol concentration in the acidic ferric sulfate solution may be at least about 0.5%, about 0.5% to about 10%, about 1% to about 9%, about 2% to about 8%, about 3% to about 7%, about 4% to about 6%, or about 10% for any bioleaching operation to not compromise any bacterial activity. The alcohol concentration in the acidic ferric chloride and/or cupric chloride solution, may be about 10%, but lower or higher concentrations (e.g., less than about 0.5% or more than about 10%) may be used. A person skilled in the art may determine the concentration of the alcohol depending on economic and operational parameters.

In an example, in an acidic ferric sulfate media and in the presence of a thiocarbonyl compound and a cosolvent as catalysts, the following reaction is facilitated:

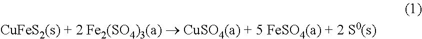

In an example, in an acidic ferric chloride and/or cupric chloride solution and in the presence of a thiocarbonyl compound and a cosolvent as catalysts, non-oxidative recovery is facilitated according to the following reactions:

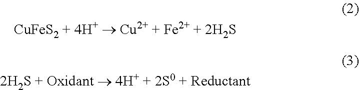

After chalcopyrite is oxidized, the dissolved copper may be recovered from the pregnant solution. The method may be applied to mineral heaps or dumps, or other contact with minerals. The method may be performed under atmospheric temperature and pressure conditions, although other temperatures and pressures may be used.

The method may comprise contacting a material with an acidic mixture. The acidic mixture further comprises an oxidizing agent. The oxidizing agent may be any suitable oxidizing agent or combination thereof, the selection of which can be made by a person skilled in the art. The oxidizing agent may comprise a reduction and/or oxidation potential. The reduction and/or oxidation potential may be at least about 50 mV, about 50 mV to about 900 mV, about 100 mV to about 800 mV, about 200 mV to about 700 mV, about 300 mV to about 600 mV, about 400 mV to about 500 mV, or about 900 mV. The oxidizing agent may comprise oxygen, a source of Fe³⁺ ions, or a combination thereof. The oxidizing agent may comprise a source of Fe³⁺ (ferric) ions. The term “source” as used herein in reference to Fe³⁺ ions may comprise both direct sources of Fe³⁺ ions and indirect sources of Fe³⁺ ions, as appropriate. The term “direct source” as used herein in reference to a source of Fe³⁺ ions refers to a substance such as a suitable water-soluble iron(III) salt that directly releases the Fe³⁺ ions upon dissolution in an aqueous environment, such as the acidic mixtures of the present invention. The term “indirect source” as used herein in reference to a source of Fe³⁺ ions refers to a source such as a suitable water soluble iron(II) salt that releases a substance such as Fe²⁺ ions upon dissolution in an aqueous environment, such as the acidic mixtures of the present invention that can be converted into the Fe³⁺ ions, e.g., by an electrochemical process. For example, the oxidizing agent can comprise a water-soluble salt such as ferric sulfate (also known as iron (III) sulfate or Fe₂(SO₄)₃) that can act as a direct source of Fe³⁺ ions and/or a water-soluble salt such as ferrous sulfate (also known as iron (II) sulfate or FeSO₄) that acts as a direct source of Fe²⁺ ions that can, for example, be oxidized into Fe³⁺ ions, e.g., by iron-oxidizing bacteria. The oxidizing agent comprises ferric sulfate. The source of ferric ions may comprise ferric ions generated at least in part by iron-oxidizing bacteria. The acidic mixture may comprise a ferric solution. The acidic mixture may comprise a ferric sulfate solution. The acidic mixture may comprise a ferric media. The acidic mixture may comprise a ferrous sulfate solution. The ferrous sulfate solution may provide a source of Fe²⁺ ions that are oxidized to Fe³⁺ ions by iron-oxidizing bacteria. The concentration of the oxidizing agent such as ferric sulfate in the acidic mixture may be any suitable concentration. Prior to the material being contacted with the cosolvent system and the catalyst comprising a thiocarbonyl, the oxidizing agent, e.g., ferric sulfate, may present in the acidic mixture at a concentration of less than 10 g/L of Fe³⁺. Prior to the material being contacted with the cosolvent system and catalyst comprising a thiocarbonyl, the oxidizing agent, e.g., ferric sulfate, may be present in the acidic mixture at a concentration of from about 0.5 g/L to about 40 g/L, about 1.5 g/L to about 3 g/L or about 2 g/L to about 2.5 g/L of Fe³⁺.

The cosolvent system may be used in either of the two mainstream acidic mixtures (e.g., lixiviants) used in copper hydrometallurgy: an acidic ferric sulfate solution (e.g., acidic ferric sulfate media) or acidic ferric chloride and/or cupric chloride solution (e.g., ferric chloride and/or cupric chloride media). The acidic ferric sulfate solution with iron oxidizing bacteria may rely on an oxidative leaching mechanism. The acidic chloride solution may rely on a non-oxidative leaching mechanism. A cosolvent system may be integrated into both systems.

The acidic ferric sulfate solution may comprise at least about 0 g, about 0 g to about 20 g, about 1 g to about 18 g, about 4 g to about 16 g, about 8 g to about 12 g, or about 20 g of iron (ferric/ferrous) as cation and sulfate as anion. The pH of the acidic ferric sulfate solution may be in the range of at least about 1, about 1 to about 3, about 1.5 to about 2.5, or about 3. Iron/sulfur oxidizing bacteria, including but not limited to, Acidithiobacillus ferrooxidans or Acidithiobacillus thiooxidans may be integrated into the acidic ferric sulfate solution. The catalyst comprising a thiocarbonyl may be added to the acidic ferric sulfate solution in concentrations of up to 100 mM of a thiocarbonyl functional group while ferric sulfate is added in concentrations of at least about 0 g/L, about 0 g/L to about 20 g/L, about 2 g/L to about 18 g/L, about 4 g/L to about 16 g/L, about 6 g/L to about 14 g/L, about 8 g/L to about 12 g/L, or about 20 g/L of ferric ion.

The acidic ferric chloride and/or cupric chloride solution may comprise at least about 25 g/L, about 25 g/L to about 180 g/L, about 50 g/L to about 150 g/L, about 75 g/L to about 125 g/L chloride. The acidic ferric chloride and/or cupric chloride solution may also comprise up to 5 g/L, at least about 0.1 g/L to about 5 g/L, about 0.5 g/L to about 4.5 g/L, about 1.0 to about 4.0 g/L, about 1.5 g/L to about 3.5 g/L, about 2.0 g/L to about 3.0 g/L of copper. The acidic ferric chloride and/or cupric chloride solution may also comprise up to 20 g/L, at least about 1 g/L to about 20 g/L, about 2 g/L to about 18 g/L, about 4 g/L to about 16 g/L, about 6 g/L to about 14 g/L, about 8 g/L to about 12 g/L iron. The acidic ferric chloride and/or cupric chloride solution may also comprise up to 2, at least about 0.5 to about 2, about 1 to about 1.5, or about 2 pH.

The material may comprise a base metal and (e.g., a base metal sulfide ore) and may comprise an iron-oxidizing bacteria. The acidic mixture may further comprise iron-oxidizing bacteria. The iron-oxidizing bacteria may be any suitable iron-oxidizing bacteria or combination (consortium) thereof, the selection of which can be made by a person skilled in the art. The iron-oxidizing bacteria may comprise, but not be limited to, Acidothiobacilos ferrooxidans.

The material comprising the base metal may be any suitable material comprising a base metal or combination thereof extractable by the processes of the present invention. For example, the material comprising the base metal may be a base metal sulfide, electronic waste (e.g., waste printed circuit boards) comprising a base metal, or any other suitable material comprising a base metal, or a combination thereof. The material comprising the base metal may comprise a base metal sulfide.

The acidic conditions are any suitable acidic condition, the selection of which can be made by a person skilled in the art. The method may comprise adding sulfuric acid to obtain the acidic conditions. The pH of the acidic mixture may be in a range of from about 0.5 to about 4, about 1 to about 3, or about 1.5 to about 2.5. The pH of the acidic mixture may be about 2.

The method may comprise contacting the material with a wetting agent. The acidic mixture may comprise the wetting agent. The wetting agent may be any suitable wetting agent or combination thereof. The term “wetting agent” as used herein refers to a substance or combination thereof that reduces the surface tension of water, and may comprise suitable surfactants that emulsify and/or disperse in addition to or alternatively, to wetting. The wetting agent may be a non-ionic wetting agent. The non-ionic wetting agent may be any suitable non-ionic wetting agent or a combination thereof. The term “non-ionic” as used herein means that the substance does not dissociate into ions in an aqueous environment such as the acidic mixtures of the present invention. The amount of the wetting agent used in the processes of the present invention is any suitable amount. For example, it will be appreciated by a person skilled in the art that in embodiments wherein iron-oxidizing bacteria are present, the amount is compatible with the presence of such bacteria, and is desirably selected such that no significant difference is observed in the growth and/or iron oxidation ability of the bacteria. The acidic mixture may comprise the wetting agent and prior to the material being contacted with the wetting agent and the reagent having the thiocarbonyl functional group, the wetting agent may be present in the acidic mixture at a concentration of from about 0.001 g/L to about 1 g/L, about 0.005 g/L to about 0.5 g/L or about 0.01 g/L to about 0.1 g/L. It will also be appreciated by a person skilled in the art that in embodiments wherein the material is agglomerated in the presence of the wetting agent, such agglomeration may lead to surfactant loss such that additional wetting agent may need to be added prior to and/or during the process to account for such loss.

The non-ionic wetting agent may be a non-ionic ethoxylate surfactant, a polyethylene glycol, or a combination thereof. The non-ionic wetting agent may be a non-ionic ethoxylate surfactant. The non-ionic ethoxylate surfactant may be any suitable non-ionic ethoxylate surfactant or a combination thereof. The term “surfactant” as used herein refers to an amphiphilic wetting agent; i.e., a substance that contains one or more hydrophobic groups and one or more hydrophilic groups arranged such that the substance is capable of acting as a wetting agent as defined herein. The term “ethoxylate surfactant” as used herein refers to a surfactant that contains at least one suitable ethylene glycol moiety, wherein each ethylene glycol moiety is of the formula —(OC₂H₄)ₙOH wherein n is typically in the range of from 1 to 20, e.g., 1 to 10. The non-ionic wetting agent may comprise polyethylene glycol. The polyethylene glycol may be any suitable polyethylene glycol or a combination thereof. For example, the skilled person will appreciate that polyethylene glycols of low molecular weight (e.g., less than about 2,000 g/mol) may be suitable wetting agents. The polyethylene glycol may have a number average molecular weight of from about 100 g/mol to about 600 g/mol or from about 100 g/mol to about 300 g/mol. The polyethylene glycol may comprise polyethylene glycol 200. The non-ionic wetting agent may comprise a combination of a non-ionic ethoxylate surfactant and a polyethylene glycol.

The non-ionic ethoxylate surfactant may comprise a polysorbate, an alkylphenyl ether of polyethylene glycol or a reduced form thereof, an alkylether of polyethylene glycol or a combination thereof. The non-ionic ethoxylate surfactant may comprise a combination of a polysorbate, an alkylphenyl ether of polyethylene glycol or a reduced form thereof and/or an alkylether of polyethylene glycol.

The non-ionic wetting agent may comprise a polysorbate. The polysorbate may be any suitable polysorbate or a combination thereof. The term “polysorbate” as used herein refers to a non-ionic surfactant derived from ethoxylated sorbitan esterified with a fatty acid and comprises combinations of such surfactants comprising a mixture of fatty acids.

The method may comprise contacting the material with a halide. The acidic mixture may comprise a halide. The halide ions may comprise chloride ions, bromide ions, iodide ions, or a combination thereof. The concentration of chloride may be about 20 g/L or less, about g/L or less, about 80 g/L or less, about 20 g/L or less, in a range of about 20 g/L to about 120 g/L, in a range of about 20 g/L to about 80 g/L, or in a range of about 20 g/L to about 50 g/L. The concentration of iodide may be about 300 ppm or less, about 100 ppm or less, or in a range of about 100 ppm to about 300 ppm. The concentration of bromide may be about 10 g/L or less, about 30 g/L or less, or in a range of about 10 g/L to about 3 0 g/L.

The method may comprise contacting the material with a carbonaceous matter. The acidic mixture may comprise a carbonaceous matter. The carbonaceous matter may be any suitable carbonaceous matter. For example, suitable carbonaceous matter is at least substantially optionally fully insoluble, and at least substantially optionally fully a solid under the recovery conditions used in the method of the present invention, and is optionally in the form of particles and/or chunks. It will be appreciated by the person skilled in the art that in some embodiments, for example, wherein the carbonaceous matter is agglomerated with the material, such particles or chunks may not exist as discrete particles or chunks but would, for example, be agglomerated together into a suitable mass. The carbonaceous matter may include, but is not limited to, carbon black, activated carbon, graphite, carbon anode scrap, charcoal, coal, solid organic carbon, carbon naturally present in the material comprising the base metal (e.g., an ore), or a combination thereof. The carbonaceous matter may comprise carbon black particles. The dosage and particle size of the carbonaceous matter can be any suitable dosage and particle size. For example, it will be appreciated by a person skilled in the art that in embodiments wherein iron-oxidizing bacteria are present, the dosage is compatible with the presence of such bacteria and is desirably selected such that no significant difference is observed in the growth and/or iron oxidation ability of the bacteria. The dosage of the carbonaceous matter may be about 1 g or lower of carbonaceous matter per gram of ore. Advantageously, a lower dosage and finer particle size of the carbonaceous matter may be used to maximize the contact between the material comprising the base metal sulfide (e.g., the chalcopyrite) and the carbonaceous matter. Accordingly, the dosage of the carbonaceous matter may be from about 0.001 g to about 0.25 g, about 0.01 g to about 0.1 g or about 0.05 g to about 0.1 g per gram of the base metal sulfide (e.g., chalcopyrite) in the material comprising the base metal sulfide. The particle size of the carbonaceous matter may be less than 500, 100 or 30 microns.

The term “catalyst comprising a thiocarbonyl” as used herein refers to an organosulfur compound comprising a C═S functional group that may also be known in the art as a thione or thioketone. The catalyst comprising a thiocarbonyl may be any suitable catalyst comprising a thiocarbonyl. For example, a suitable catalyst comprising a thiocarbonyl may feature a C═S functional group having a sulfur bearing a partial negative charge, bearing a negative electrostatic potential surface and having an empty x′-antibonding orbital as its lowest unoccupied molecular orbital (LUMO), provided that the catalyst comprising a thiocarbonyl is at least partially soluble in water and preferably does not significantly complex with a base metal and/or (if present) the oxidizing agent to form insoluble precipitates. Certain catalysts comprising a thiocarbonyl may oxidize to form the corresponding dimer. For example, thiourea, in the presence of a suitable oxidant such as ferric sulfate, is capable of oxidizing to form the dimer formamidine disulfide (FDS). An equilibrium exists between FDS and thiourea in a ferric sulfate solution such that, for example, an acidic mixture prepared with a dimer of a catalyst comprising a thiocarbonyl (e.g., FDS) will provide a catalyst comprising a thiocarbonyl for contacting the material. Accordingly the catalyst may comprise a thiocarbonyl added to the process in the form of the corresponding dimer. The catalyst comprising a thiocarbonyl may be added to the method in monomeric form (i.e., in the form of the catalyst comprising a thiocarbonyl).

The catalyst comprising a thiocarbonyl may comprise thiourea, FDS, N—N′ substituted thioureas; 2,5-dithiobiurea; dithiobiuret; thiosemicarbazide purum; thiosemicarbazide; thioacetamide; 2-methyl-3-thiosemicarbazide; 4-methyl-3-thiosemicarbazide; vinylene trithiocarbonate purum; vinylene trithiocarbonate; 2-cyanothioacetamide; ethylene trithiocarbonate; potassium ethyl xanthogenate; dimethylthiocarbamoyl chloride; dimethyldithiocarbamate; dimethyl trithiocarbonate; N,N-dimethylthioformamide; 4,4-dimethyl-3-thiosemicarbazide; 4-ethyl-3-thiosemicarbazide; O-isopropylxanthic acid; ethyl thiooxamate; ethyl dithioacetate; pyrazine-2-thiocarboxamide; diethylthiocarbamoyl chloride; diethyldithiocarbamate; tetramethylthiuram monosulfide; tetramethylthiuram disulfide; pentafluorophenyl chlorothionoformate; 4-fluorophenyl chlorothionoformate; O-phenyl chlorothionoformate; phenyl chlorodithioformate; 3,4-difluorothiobenzamide; 2-bromothiobenzamide; 3-bromothiobenzamide; 4-bromothiobenzamide; 4-chlorothiobenzamide; 4-fluorothiobenzamide; thiobenzoic acid; thiobenzamide; 4-phenylthiosemicarbazide; O-(p-tolyl) chlorothionoformate; 4-bromo-2-methylthiobenzamide; 3-methoxythiobenzamide; 4-methoxythiobenzamide; 4-methylbenzenethioamide; thioacetanilide; salicylaldehyde thiosemicarbazone; indole-3-thiocarboxamide; S-(thiobenzoyl)thioglycolic acid; 3-(acetoxy)thiobenzamide; 4-(acetoxy)thiobenzamide; methyl N′-[(e)-(4-chlorophenyl)methylidene]hydrazonothiocarbamate; 3-ethoxythiobenzamide; 4-ethylbenzene-1-thiocarboxamide; tert-butyl 3-[(methylsulfonyl)oxy]-1-azetanecarboxylate; diethyldithiocarbamic acid; 2-(phenylcarbonothioylthio)-propanoic acid; 2-hydroxybenzaldehyde N-ethylthiosemicarbazone; (1R,4R)-1,7,7-trimethylbicyclo[2.2.1]heptane-2-thione; tetraethylthiuram disulfide; 4′-hydroxybiphenyl-4-thiocarboxamide; 4-biphenylthioamide; dithizone; 4′-methylbiphenyl-4-thiocarboxamide; tetraisopropylthiuram disulfide; anthracene-9-thiocarboxamide; phenanthrene-9-thiocarboxamide; sodium dibenzyldithiocarbamate; 4,4′-bis(dimethylamino)thiobenzophenone; or a combination thereof. The catalyst comprising a thiocarbonyl may comprise thiourea, ethylene thiourea, thioacetamide, sodium dimethyldithiocarbamate, trithiocarbonate, thiosemicarbazide or a combination thereof.

The concentration of the catalyst comprising a thiocarbonyl in the acidic mixture may be any suitable concentration. In embodiments wherein the catalyst comprising a thiocarbonyl is added to the process in the form of the corresponding dimer, the concentrations specified herein for the catalyst comprising a thiocarbonyl refers to a concentration calculated as if all of the dimer was dissociated into the reagent having the thiocarbonyl functional group. Prior to the material being contacted with the cosolvent and the catalyst comprising a thiocarbonyl, the catalyst comprising a thiocarbonyl may be present in the acidic mixture at a concentration of about 0.002 mM or greater, about 0.02 mM or greater, about 0.1 mM or greater, about 0.2 mM or greater, about 0.25 mM or greater, about 0.3 mM or greater, about 0.4 mM or greater, about 0.5 mM or greater, about 0.6 mM or greater, about 0.7 mM or greater, about 0.8 mM or greater, about 0.9 mM or greater, about 1.0 mM or greater, about 1.5 mM or greater, about 2 mM or greater, about 2.5 mM or greater, about 3 mM or greater, about 4 mM or greater, about 5 mM or greater, about 10 mM or greater, about 20 mM or greater, about 30 mM or greater, or about 60 mM or greater. Prior to the material being contacted with the cosolvent and the catalyst comprising a thiocarbonyl, the catalyst comprising a thiocarbonyl may be present in the acidic mixture at a concentration of about 100 mM or lower, about 60 mM or lower or about 30 mM or lower. Prior to the material being contacted with the cosolvent and the catalyst comprising a thiocarbonyl, the reagent having the catalyst comprising a thiocarbonyl may be present in the acidic mixture at a concentration of about 20 mM or lower. A lower concentration of the catalyst comprising a thiocarbonyl may be used. Accordingly, prior to the material being contacted with the cosolvent and the catalyst comprising a thiocarbonyl, the catalyst comprising a thiocarbonyl may be present in the acidic mixture at a concentration of about 10 mM or lower, about 5 mM or lower, about 4 mM or lower, about 3 mM or lower, about 2.5 mM or lower, about 2 mM or lower, about 1.5 mM or lower, about 1.0 mM or lower, about 0.9 mM or lower, about 0.8 mM or lower, about 0.75 mM or lower, about 0.7 mM or lower, about 0.6 mM or lower, about 0.5 mM or lower, about 0.4 mM or lower, about 0.3 mM or lower, about 0.2 mM or lower, about 0.02 mM or lower, or about 0.002 mM or lower. It will be appreciated by a person skilled in the art that such embodiments can be interchanged in any suitable manner. For example, prior to the material being contacted with the cosolvent and the catalyst comprising a thiocarbonyl, the catalyst comprising a thiocarbonyl may present in the acidic mixture at a concentration of from about 0.002 mM to about 100 mM, about 0.2 mM to about 100 mM, about 0.2 mM to about 20 mM, about 0.1 mM to about 10 mM, about 0.2 mM to about 10 mM, about 0.2 mM to about 5 mM, about 0.2 mM to about 4 mM, about 0.2 mM to about 3 mM, about 0.25 mM to about 2.5 mM, about 0.2 mM to about 2 mM, about 0.2 mM to about 1.5 mM, about 0.2 mM to about 1.0 mM, about 0.2 mM to about 0.5 mM, about 0.25 mM to about 0.75 mM, about 1.5 mM to about 2.5 mM, about 0.5 mM or about 2 mM.

The material can be contacted with the cosolvent and the catalyst comprising a thiocarbonyl using any suitable process and/or means, the selection of which can be made by a person skilled in the art. The material may be contacted with the cosolvent and the catalyst comprising a thiocarbonyl in a method comprising a percolation leach (e.g., a heap leach, a dump leach, or a column leach), a tank leach, a vat leach, a bioreactor, or a combination thereof. The material may be contacted with the cosolvent and the catalyst comprising a thiocarbonyl in a method comprising a percolation leach (e.g., a heap leach, a dump leach, or a column leach), a tank leach or a vat leach. The percolation leach may be a heap leach, a dump leach, a column leach, or a combination thereof. The material may be contacted with the cosolvent and the catalyst comprising a thiocarbonyl in a method comprising a percolation leach. The material may be contacted with the cosolvent and the catalyst comprising a thiocarbonyl in a method comprising a heap leach. The material may be contacted with the cosolvent and the catalyst comprising a thiocarbonyl in a method comprising a dump leach. The material may be contacted with the cosolvent and the catalyst comprising a thiocarbonyl in a method comprising a column leach. The material may be contacted with the cosolvent and the catalyst comprising a thiocarbonyl in a method comprising a tank leach. The material may be contacted with the cosolvent and the catalyst comprising a thiocarbonyl in a method comprising a vat leach. The material may be contacted with the carbonaceous matter and the catalyst comprising a thiocarbonyl in a method comprising a bioreactor. Suitable processes, means and/or conditions for carrying out a percolation leach (e.g., a heap leach, a dump leach, or a column leach), a tank leach, a vat leach or a leach in a bioreactor in the processes of the present invention may be selected by the person skilled in the art.

For example, the term “percolation leach” as used herein refers to a process in which the base metal is leached from the material by causing the acidic mixture to seep into and flow through a mass of the material (or, in some embodiments of the present invention, a mass of the material combined e.g., agglomerated, with the cosolvent).

The term “heap leach” as used herein refers to an example of a percolation leach which comprises heaping the material (such as the ore) onto a heap leach pad (e.g., an impermeable plastic or clay-lined leach pad), and contacting (e.g., irrigating via a means such as a sprinkler or drip irrigation) the heaped material with the acidic mixture in a way such that the acidic mixture percolates through the heap and leaches the base metal, for example, so as to obtain a pregnant leach solution comprising the base metal which can be collected. In heap leach processes, the material (such as the ore) may be crushed subsequent to being removed from the ground and prior to being heaped. The crushing may be primary crushing, secondary crushing, tertiary crushing, or a combination thereof. It will be appreciated by the person skilled in the art that in embodiments wherein the material is combined e.g., agglomerated, with the cosolvent, such combining may be carried out prior to the material (such as the ore) and the cosolvent being heaped, and, in embodiments comprising crushing the material (such as the ore), subsequent to the crushing of the material.

The term “dump leach” as used herein refers to an example of a percolation leach having a process that is similar to a heap leach, but wherein the material (such as the ore) is not crushed prior to being stacked on the leach pad.

The term “column leach” as used herein refers to an example of a percolation leach which comprises loading the material (such as the ore) into a column, then contacting (e.g., irrigating via a means such as drip irrigation from the top of the column) the material with the acidic mixture in a way such that the acidic mixture percolates through the material in the column and leaches the base metal, for example, so as to obtain a pregnant leach solution comprising the base metal which can be collected. The material (such as the ore) is crushed prior to being loaded in the column. It will be appreciated by the person skilled in the art that in embodiments wherein the material is combined, e.g., agglomerated with the cosolvent, such combining, e.g., agglomeration, is carried out prior to the material (such as the ore) and the cosolvent being loaded, and, in embodiments comprising crushing the material (such as the ore), subsequent to the crushing of the material. Column leaches can be useful, for example, for measuring the effects of typical variables encountered in industrial heap and/or dump leaching processes.

The terms “tank leach” and “vat leach” as used herein refer to processes in which the material (such as the ore) is placed into a tank or vat, respectively, containing the acidic mixture under conditions suitable to leach the base metal, for example, to obtain a pregnant leach solution comprising the base metal which can be collected. In exemplary tank leaching processes, the material (such as the ore) is typically ground to a fineness suitable to form a slurry or pulp, combined with water to form the slurry or pulp, then pumped into the tank where subsequently the acidic mixture is added. In exemplary vat leaching processes, a coarser particle size of the material (such as the ore) is used which is loaded into the vat as a solid, then the acidic mixture is flooded into the vat.

The person skilled in the art will appreciate that the term “acidic mixture” as used herein comprises both an acidic aqueous solution and an acidic aqueous suspension, depending on the components comprised therein. The acidic mixture used in the various embodiments of the present invention can readily be prepared by the person skilled in the art in regard to the present invention by combining the various components therein by a suitable process and/or means. For example, in some embodiments comprising the oxidizing agent (such as ferric sulfate), the acidic mixture may be prepared by a process comprising adjusting the pH of an aqueous solution comprising the desired amount of the oxidizing agent (such as ferric sulphate) with a suitable acid (such as sulfuric acid) to a suitable value (such as a pH of about 2) to obtain an acidic aqueous solution comprising the oxidizing agent, then adding the desired amount of the reagent having the thiocarbonyl functional group (or dimer thereof) to obtain the acidic mixture. For example, wherein the cosolvent is not combined, e.g., agglomerated, with the material (such as the ore), the preparation of the acidic mixture may further comprise mixing the desired amount of the cosolvent in the acidic aqueous solution comprising the oxidizing agent to obtain the acidic mixture. The mixing may be prior to the addition of the catalyst comprising a thiocarbonyl (or dimer thereof). The mixing may be subsequent to the addition of the catalyst comprising a thiocarbonyl (or dimer thereof).

The method may comprise recovering the base metal. For example, the base metal may be recovered from the pregnant leach solution in embodiments wherein the contacting of the material with the cosolvent and the catalyst comprising a thiocarbonyl produces a pregnant leach solution comprising the base metal. In embodiments wherein the method comprises recovering the base metal (e.g., from the pregnant leach solution), the method for recovering the base metal may be any suitable process, the selection of which can be made by the person skilled in the art. For example, where the material comprises chalcopyrite, in the presence of the cosolvent and catalyst comprising a thiocarbonyl, the following reaction is facilitated:

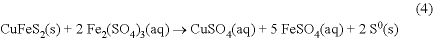

After the chalcopyrite is oxidized, the dissolved base metal may be recovered (e.g., from the pregnant leach solution). The recovering of the base metal (such as copper) may comprise solvent extraction and electrowinning. Prior to the solvent extraction, the method may comprise a solid-liquid separation.

The method may further comprise recovering the catalyst comprising a thiocarbonyl. For example, the catalyst comprising a thiocarbonyl may be recovered from the pregnant leach solution in embodiments wherein the contacting of the material with the cosolvent and the catalyst comprising a thiocarbonyl produces a pregnant leach solution comprising the base metal. For example, iron and copper ions may be present (e.g., in the pregnant leach solution). A person skilled in the art will appreciate that a catalyst comprising a thiocarbonyl may form various stable complexes with base metal ions. Extractants commonly used for solvent extraction of base metal ions, such as hydroxyoximes and aldoximes, are strong complexing agents for the copper ions. The extractants may change the equilibrium between base metal ions and catalyst comprising a thiocarbonyl which are acting as ligands, releasing the catalyst comprising a thiocarbonyl from the base metal and catalyst complex. As the free catalyst comprising a thiocarbonyl enters the raffinate solution, it may be recirculated for further contacting with the material. The solvent extraction may comprise contacting the base metal cations (e.g., in the pregnant leach solution) with an extractant for base metal cations in the presence of an organic solvent. The skilled person will be able to select a suitable organic solvent or combination thereof depending on the base metal cation to be extracted. The organic solvent may an aliphatic solvent, an aromatic solvent, or a combination thereof. The organic solvent may comprise kerosene, alkyl aromatics, cyclo-paraffins, or a combination thereof. The skilled person will also be able to select an appropriate extractant for the base metal cation. The extractant for the base metal cation may be an aldoxime, a ketoxime, or a combination thereof. The contacting may be further carried out in the presence of an ester modifier, an alkylphenol modifier, or a combination thereof. During the solvent extraction, base metal cations may be de-complexed from the catalyst comprising a thiocarbonyl, thus liberating the catalyst, and allowing the base metal cation to be extracted (e.g., from the pregnant leach solution) into the organic solvent. The free catalyst comprising a thiocarbonyl remains in the aqueous phase. The retention of the free catalyst comprising a thiocarbonyl in the aqueous phase during solvent extraction to produce the raffinate comprising the free catalyst is accomplished with halides, e.g., chloride, bromide, or iodide, present (e.g., in the pregnant leach solution). Separation of the organic solvent from the aqueous phase results in a base metal cation-depleted raffinate comprising the free catalyst comprising a thiocarbonyl, and a base metal cation-enriched organic phase comprising the organic solvent and base metal cations. The base metal cation-enriched solution may then be processed (e.g., by a process comprising electrowinning) to recover the base metal. The raffinate can optionally be recirculated for use in the process. Accordingly, the method optionally further comprises recycling the recovered catalyst comprising a thiocarbonyl for use in the contacting of a further portion of the material. Additional catalyst comprising a thiocarbonyl (or dimer thereof) may be added to reach a desired concentration prior to the contacting with the material. A reducing agent may be added prior to the contacting with the material. The reducing agent may include, but is not limited to, H₂S, NaSH or Zn. The reducing agent may be added in an amount to obtain a ratio of catalyst comprising a thiocarbonyl to corresponding dimer in a range of about 0.5:1 to about 9:1.

The contacting of the material with the cosolvent and the catalyst comprising a thiocarbonyl may be carried out under any suitable temperature and pressure conditions. For example, the contacting can be carried out at a temperature greater than 0° C. to about 80° C. However, the contacting in the processes of the present invention is advantageously carried out at ambient temperature (e.g., from about 5° C. to about 40° C. or about 15° ° C. to about 25° C.) and pressure (e.g., about 1 atm).

The method may be a batch process, a continuous process, or a combination thereof.

The present invention also comprises a use of a cosolvent and a catalyst comprising a thiocarbonyl in a method for extracting a base metal from a material comprising the base metal. The method is any method for extracting a base metal from a material comprising the base metal as described herein.

The present invention also comprises a use of cosolvent and a catalyst comprising a thiocarbonyl in a method for extracting (e.g., leaching) and optionally recovering a base metal from a material comprising the base metal. The method may comprise recovering the base metal. Accordingly, the present invention also comprises a use of a cosolvent and a catalyst comprising a thiocarbonyl in a method for extracting (e.g., leaching) and recovering a base metal from a material comprising the base metal. The use may or may not comprise recovering the base metal. Accordingly, the present invention also comprises a use of a cosolvent and a catalyst comprising a thiocarbonyl in a method for extracting (e.g., leaching) a base metal from a material comprising the base metal. The process may be any process for extracting (e.g., leaching) and optionally recovering a base metal from a material comprising the base metal as described herein.

The present invention also comprises a use of a cosolvent and catalyst comprising a thiocarbonyl for extracting a base metal from a material comprising the base metal, wherein the material is contacted under acidic conditions with the cosolvent and the catalyst comprising a thiocarbonyl.

The present invention also comprises a use of a cosolvent and a catalyst comprising a thiocarbonyl for extracting (e.g., leaching) and optionally recovering a base metal from a material comprising the base metal, wherein the material is contacted under acidic conditions with the cosolvent and the catalyst comprising a thiocarbonyl. The use may comprise recovering the base metal. Accordingly, the present invention also comprises a use of a cosolvent and a catalyst comprising a thiocarbonyl for extracting (e.g., leaching) and recovering a base metal from a material comprising the base metal, wherein the material is contacted under acidic conditions with the cosolvent and the catalyst comprising a thiocarbonyl. The use may not comprise recovering the base metal. Accordingly, the present invention also comprises a use of cosolvent and a catalyst comprising a thiocarbonyl for extracting (e.g., leaching) a base metal from a material comprising the base metal, wherein the material is contacted under acidic conditions with the cosolvent and the catalyst comprising a thiocarbonyl.

The material is contacted with the cosolvent and the catalyst comprising a thiocarbonyl by any suitable process.

The material may be contacted with the cosolvent and the catalyst comprising a thiocarbonyl by a method comprising: contacting the cosolvent with the material; and contacting the combined cosolvent and material with an acidic mixture comprising the catalyst comprising a thiocarbonyl. The cosolvent may be agglomerated with the material. Processes for agglomerating are well known in the art and a suitable process for agglomeration of the cosolvent and the material may be selected by the skilled person.

The material may be contacted with the cosolvent and the catalyst comprising a thiocarbonyl by a method comprising contacting the material with an acidic mixture comprising the cosolvent and catalyst comprising a thiocarbonyl.

Embodiments of the present invention provide a technology-based solution that overcomes existing problems with the current state of the art in a technical way to satisfy an existing problem for the extraction of metal from a material. Embodiments of the present invention achieve important benefits over the current state of the art, such as improved metal recovery. Some of the unconventional steps of embodiments of the present invention comprise contacting a material with a catalyst comprising a thiocarbonyl group and cosolvent.

### INDUSTRIAL APPLICABILITY

The invention is further illustrated by the following non-limiting examples.

### Example 1

One of the beneficial effects of using a water-alcohol cosolvent system is the lowering of the surface tension. Lower surface tension enhanced the permeability of the lixiviant through fine particles or crevices. 10% of ethylene glycol (EG) or 1-propanol substitution of water showed a significant decrease of surface tension by 8% and 52%, respectively.

### Example 2

Freshly crushed pure chalcopyrite ores were leached in a standard acidic ferric sulfate leaching condition in comparison with the leaching in a cosolvent system. Ethylene glycol (EG), one of the most common polyhydric alcohols, was used in this experiment. In all tests, 5 g of pulverized chalcopyrite mineral was used. A control test was carried out using the freshly crushed mineral and the general leaching condition described above. A water-and-10%-EG cosolvent test (“10% EG”) was run under the same condition as the control test, except for the substitution of 10% (volume ratio) of water with EG as solvent.

It was observed that in the control test, a copper extraction of 9.7% was reached at 696 hours. When a water-EG cosolvent was used, the copper extraction was increased to 14.7% for the same amount of testing time. This example confirmed the beneficial effect of ethylene glycol in acidic ferric sulfate leaching conditions under ambient conditions.

### Example 3

Three parallel tests were conducted through a two-phased experiment. In phase one, all three reactors were operating under a standard bioleaching condition for 456 hours to establish a controlled baseline. In all tests, 5 g/L of pulverized chalcopyrite mineral was used. Phase 2 started after 456 hours. Ethylene glycol (EG), a polyhydric alcohol, was used in the test. Thiourea (TU), a thiocarbonyl compound, was also used in this example. The control test (“Control”) was carried out using the freshly crushed mineral and the general leaching condition described above. A TU test (“Control+TU”) was run under the same condition as the control test, except for the addition of 0.5 mM thiourea after 456 hours of the test. An EG test (“Control+EG”) was run under the same condition as the control test, except for the substitution of 1% of EG after 456 hours of the test. An EG and TU test (“Control+EG+TU”) was run under the same condition as the control test, except for the substitution of 1% of EG after 456 hours of the test and addition of 0.5 mM of TU.

It was observed that in phase 1, all three reactors had almost identical leaching behavior with an extraction rate of 0.013%/hour. All reactors reached ˜6% copper extraction at 456 hours. In phase 2, when reagents were added to the system, an immediate increase of leaching rate was observed for all reactors. For all three reactors, the addition of 1% EG, 0.5 mM of TU and the combination of 1% EG+0.5 mM of TU increased their leaching rate to 0.016, 0.039 and 0.041%/hour, respectively. A positive synergy was observed when EG and TU were used together. At 2376 hours, the Control+EG+TU test showed 47.04% copper extraction compared with using pure TU or EG separately, where only 37.85% and 25.82% of copper was extracted.

### Example 4

Five parallel tests were performed to examine the effect of cosolvent on the stability of thiocarbonyl compound that has been used as a catalyst in an acidic ferric sulfate leaching system. 1 mM of thiourea, a thiocarbonyl compound, was used in these tests. The solution matrix was lixiviant containing 2.2 g/L Fe³⁺ from ferric sulfate adjusted by sulfuric acid to pH 2. Ethylene glycol (EG), a polyhydric alcohol, and 1-propanol (1-P), a monohydric alcohol, were used in this example to form a co-solvent with water. The oxidation reaction of TU by ferric ion is shown below:

$$2 TU + 2 {Fe}^{3 +} \to 2 {Fe}^{2 +} + FDS + 2 {H}^{+} \qquad ( 5 )$$

As can be seen in FIG. 4, the use of a co-solvent with ethylene glycol or 1-propanol improved the stability of thiourea in the solution matrix. Higher TU concentration was observed in all water alcohol co-solvent systems compared with the control solution (aqueous only).

### Example 5

Three parallel tests were performed to examine the effect of a co-solvent on the stability of formamidine disulfide (FDS). Although FDS did not have a thiocarbonyl functional group, it was closely related with thiourea (TU) since it is the oxidation product of TU. In this example, the solution matrix was deionized water acidified by H₂SO₄ to pH 2. Ethylene glycol (EG), a common polyhydric alcohol, and 1-propanol (1-P), a monohydric alcohol, were used in this example to form a co-solvent with water. 1% of each alcohol was used to form a co-solvent system with water. 1 mM of FDS was used as initial feed for all tests. The FDS concentration was measured by high-performance liquid chromatography (“HPLC”) to monitor its change over time in different solvent systems. The reaction of FDS-hydrolyze in water was shown in the following reaction:

$$FDS \to TU + Cyanamide + {S}^{0} \qquad ( 6 )$$

As can be seen in FIG. 5, the use of a co-solvent with ethylene glycol or 1-propanol improved the stability of FDS in the water-alcohol solution matrix.

### Example 6

Three parallel tests were conducted using acidic chloride as a lixiviant. In all tests, 5 g/L of pulverized chalcopyrite mineral was used. Ethylene glycol (EG) as one of the most common polyhydric alcohols was used in one example. 1-propanol (1-P), a monohydric alcohol, was used in the other example. The control test was carried out using the freshly crushed mineral and the acidic chloride leaching condition mentioned above. Water was the only solvent in the control group. A 1% ethylene glycol test (“1% EG”) was run under the same condition as the control test, except for the substitution of 1% solvent by ethylene glycol at the beginning of the test. A 1-propanol test (“1% 1-P”) was run under the same condition as the control test, except for the substitution of 1% solvent by 1-propanol at the beginning of the test.

It was observed that after 360 hours of operation, compared with the control group, the cosolvent system containing 1% EG and 1% or 1-propanol, increased their copper extraction from 4.62% to 5.39 and 8.26%, respectively.

### Example 7

Two parallel tests were conducted using acidic chloride as lixiviant. In all tests, 5 g/L of pulverized chalcopyrite mineral was used. A control test with only an aqueous system was used in one example. Ethylene glycol (EG), a monohydric polyhydric alcohol, was used in the other example for comparison. The control test was carried out using the freshly crushed mineral and the acidic chloride leaching condition mentioned above with the addition of 5 g/L of ferric ion as oxidant. Water was the only solvent in the control group. A 0.1% ethylene glycol test (“0.1% EG”) was run under the same condition as the control test, except for the substitution of 0.1% solvent by ethylene glycol at the beginning of the test.

### Example 8

Freshly crushed pure chalcopyrite ores were leached in a standard acidic ferric sulfate leaching condition in comparison with the leaching in a cosolvent system. 1,1,1-tris(hydroxymethyl)propane (TMP) (also referred to as trimethylolpropane) and pentaerythritol (Penta) two of the most common polyhydric alcohols, were used in this experiment. In all tests, 5 g/L of pulverized chalcopyrite mineral was used. A control test was carried out using the freshly crushed mineral and the general leaching condition described above. A thiourea control test (Control+T) was run under the same conditions as the control test, except for the addition of 0.5 mM thiourea at the beginning of the test. A TMP control test was run under the same conditions as the control test, except for the substitution of 1% of water by TMP at the beginning of the test. A thiourea and TMP test (TMP+T) was run under the same conditions as the control test except for the addition of 0.5 mM of thiourea and 1% substitution of TMP. A Penta control test was performed under the same conditions as the control test, except for the substitution of 1% of water by pentaerythritol at the beginning of the test. A thiourea and pentaerythritol test (Penta+T) was run under the same conditions as the control test except for the addition of 0.5 mM of thiourea and 1% substitution of pentaerythritol. The copper recovery of each test at 1368 hours are 13.94% (Control), 23.10% (Control+T), 9.42% (TMP), 34.45% (TMP+T), 14.14% (Penta) and 29.92% (Penta+T). It was observed that the use of thiourea alone enhanced the extraction of copper whereas the cosolvent (TMP or Penta) alone has no beneficial effect. However, combining thiourea and cosolvent system (TMP or Penta) together created significant positive synergistic effect.

### Example 9

A thiocarbonyl compound, thiourea, was used in a stability test. The base solution contained 40 mM ferric ion made from ferric sulfate. The pH of the solution was adjusted to 1.7 by H₂SO₄. Pure pyrite and chalcopyrite minerals were used in the tests. Gluconic acid was used as the representative for the a carboxylic acids that contains a hydroxyl substitution. Gluconic solution (50%) was used as the starting reagent. The final concentration of gluconic acid was 10 mM for tests 3, 6, 9, and 12. Ethanol was used as a monoprotic alcohol. The tests 2, 5, 8, and 11 used a mixture of 20% ethanol and 80% water.

TABLE 2
12 tests prepared with an ethanol or gluconic acid cosolvent.

| # | Minerals | Purged gas | Cosolvent |
|---|---|---|---|
| 1 | Pyrite | N₂ | NA |
| 2 | Pyrite | N₂ | Ethanol |
| 3 | Pyrite | N₂ | Gluconic Acid |
| 4 | Pyrite | O₂ | NA |
| 5 | Pyrite | O₂ | Ethanol |
| 6 | Pyrite | O₂ | Gluconic Acid |
| 7 | Chalcopyrite | N₂ | NA |
| 8 | Chalcopyrite | N₂ | Ethanol |
| 9 | Chalcopyrite | N₂ | Gluconic Acid |
| 10 | Chalcopyrite | O₂ | NA |
| 11 | Chalcopyrite | O₂ | Ethanol |
| 12 | Chalcopyrite | O₂ | Gluconic Acid |

The remaining thiourea was measured by high performance liquid chromatography after ten days of agitation. It was observed that oxygen was one of the main reasons that thiourea decomposed. Both gluconic acid and ethanol had the ability to prevent the decomposition of thiourea.

### Example 10

Chalcopyrite concentrates were leached in a standard acidic ferric sulfate leaching condition in comparison with the leaching in a cosolvent system. Oxalic acid (OX), a polyprotic carboxylic acid, was used in the experiment. Thiourea (TU), a thiocarbonyl compound, was also used. In all tests, 5 g of pulverized chalcopyrite mineral was used. The control test (Control) was carried out using the chalcopyrite concentrate mineral and the general leaching conditions were a base solution containing 40 mM ferric ion made from ferric sulfate. The pH of the solution was adjusted to 1.7 by H₂SO₄. A TU test (Control+TU) was run under the same condition as the control test, except for the addition of 2 mM thiourea in the beginning of the test. A TU mixed with oxalic acid test (TU+OX) was run under the same condition as the TU test, except for the addition of 10 mM oxalic acid in the test.

It was observed that in the control test, a copper extraction of 36% was reached at 10 days of leaching. The copper extraction was increased to 49% with the addition of 2 mM of TU for the same amount of testing time. The copper extraction was further increased to 60% with the addition of 2 mM of TU and 10 mM of oxalic acid for the same amount of testing time. This example confirmed the beneficial effect of oxalic acid in acidic ferric sulfate leaching conditions under ambient conditions.

After 336 hours of operation, compared with the control group, the cosolvent system containing 0.1% EG increased the copper extraction from 8.2% to 14.5%, respectively. This example showed that the use of a cosolvent system overcame the detrimental effect caused by ferric ion.

The preceding examples can be repeated with similar success by substituting the generically or specifically described reactants and/or operating conditions of this invention for those used in the preceding examples.

All cosolvent percentages are by volume. Unless otherwise indicated, the definitions and embodiments described in this and other sections are intended to be applicable to all embodiments and aspects of the invention herein described for which they would be understood to be suitable by a person skilled in the art.

As used herein, the words “comprising” (and any form thereof, such as “comprise” and “comprises”), “having” (and any form thereof, such as “have” and “has”), “including” (and any form thereof, such as “include” and “includes”) or “containing” (and any form thereof, such as “contain” and “contains”), are inclusive or open-ended and do not exclude additional, unrecited elements or process/method steps.

The term of degree “substantially” as used herein mean a reasonable amount of deviation of the modified term such that the end result is not significantly changed. These terms of degree should be construed as including a deviation of at least ±5% of the modified term if this deviation would not negate the meaning of the term it modifies. Note that in the specification and claims, “about” or “approximately” means within twenty percent (20%) of the numerical amount cited.

As used in this application, the singular forms “a”, “an” and “the” include plural references unless the content clearly dictates otherwise.

The term “and/or” as used herein means that the listed items are present, or used, individually or in combination. In effect, this term means that “at least one of” or “one or more” of the listed items is present or used.

Although the invention has been described in detail with particular reference to these embodiments, other embodiments can achieve the same results. Variations and modifications of the present invention will be obvious to those skilled in the art. The entire disclosures of all references, applications, patents, and publications cited above are hereby incorporated by reference.

What is claimed is:

1. A method for extracting a base metal from a material, the method comprising:
contacting the material under acidic conditions with a cosolvent system and a catalyst comprising a thiocarbonyl.

2. The method of claim 1 wherein contacting the material under acidic conditions comprises:
contacting the material with an acidic mixture comprising the catalyst comprising a thiocarbonyl.

3. The method of claim 1 wherein the material is agglomerated prior to contact.

4. The method of claim 2 wherein the acidic mixture comprises an oxidizing agent.

5. The method of claim 4 wherein the oxidizing agent comprises ferric sulfate.

6. The method of claim 1 wherein the material comprises an iron-oxidizing bacteria.

7. The method of claim 2 wherein the acidic mixture comprises an iron-oxidizing bacteria.

8. The method of claim 1 wherein the material comprises a base metal sulfide.

9. The method of claim 1 wherein the material comprises an ore.

10. The method of claim 1 wherein the base metal comprises copper.

11. The method of claim 1 wherein the material comprises a copper sulfide ore.

12. The method of claim 11 wherein the copper sulfide ore comprises chalcopyrite.

13. The method of claim 1 further comprising adding sulfuric acid to obtain the acidic conditions.

14. The method of claim 2 wherein the pH of the acidic mixture is in a range of about 1.5 to about 2.5.

15. The method of claim 1 wherein the catalyst comprising a thiocarbonyl is added to the method in monomeric form.

16. The method of claim 1 wherein the catalyst comprising a thiocarbonyl is added to the method in the form of the corresponding dimer.

17. The method of claim 1 wherein the catalyst comprising a thiocarbonyl comprises thiourea.

18. The method of claim 1 wherein the cosolvent system comprises an acid.

19. The method of claim 18 wherein the acid comprises carboxylic acid.

20. The method of claim 1 wherein the cosolvent system comprises a cosolvent.

21. The method of claim 20 wherein the cosolvent comprises an alcohol.

22. The method of claim 21 wherein the alcohol comprises a monohydric alcohol.

23. The method of claim 22 wherein the monohydric alcohol comprises propanol.

24. The method of claim 21 wherein the alcohol comprises a polyhydric alcohol.

25. The method of claim 24 wherein the polyhydric alcohol comprises ethylene glycol.

26. The method of claim 20 wherein the cosolvent comprises a solubility in water of about 0.2 g/L to about 10 g/L.

27. The method of claim 21 wherein the alcohol is at a concentration in the range of about 0.5% to about 10%.

28. The method of claim 1 wherein the catalyst comprising a thiocarbonyl is at a concentration in the range of about 0.002 mM to about 100 mM.

29. The method of claim 2 wherein the acidic mixture comprises ferric chloride.

30. The method of claim 1 wherein the material is contacted with the cosolvent system and the catalyst comprising a thiocarbonyl in a method comprising a percolation leach.

31. The method of claim 1 wherein the material is contacted with the cosolvent system and the catalyst comprising a thiocarbonyl in a method comprising a heap leach.

32. The method of claim 1 wherein the material is contacted with the cosolvent system and the catalyst comprising a thiocarbonyl in a method comprising a percolation leach.

33. The method of claim 1 further comprising recovering the base metal.

34. The method of claim 1 wherein the contacting of the material with the cosolvent system and the catalyst comprising a thiocarbonyl produces a pregnant leach solution comprising the base metal and the method further comprises recovering the base metal from the pregnant leach solution.

35. The method of claim 33 wherein the recovering comprises solvent extraction.

36. The method of claim 33 wherein the recovering comprises electrowinning.

37. The method of claim 35 further comprising a solid-liquid separation.

38. The method of claim 1 further comprising recovering the catalyst comprising a thiocarbonyl.

39. The method of claim 38 further comprising recycling the recovered catalyst comprising a thiocarbonyl for use in the contacting of a further portion of the material.

40. The method of claim 1 wherein the material is contacted with the cosolvent system and the catalyst comprising a thiocarbonyl at ambient temperature and pressure.

41. The method of claim 1 wherein the method is a batch method.

42. The method of claim 1 wherein the method is a continuous method.
